(19) United States
(12) Patent Application Publication
(10) Pub. No.: US 2005/0285513 A1
(43) Pub. Date: Dec. 29, 2005

(54) Organic electroluminescent display device having improved water absorbing capacity and method of manufacturing the same

(76) Inventors: Dong-Soo Choi, Suwon-si (KR); Dong-Won Han, Suwon-si (KR); Seung-Yong Song, Suwon-si (KR)

Correspondence Address: Robert E. Bushnell;Attorney-at-Law, Suite 300, 1522 "K" Street, N.W., Washington, DC, 20005-1202, US

(21) Appl. No.: 11/166,777

(22) Filed: Jun. 27, 2005

(30) Foreign Application Priority Data
Jun. 29, 2004 (KR) 10-2004-0049711

(51) Int. Cl. H01J 1/62; H01J 63/04

(52) U.S. Cl. 313/504

(57) ABSTRACT

An organic electroluminescent display device has a sealing substrate, an organic electroluminescent element which is formed on the sealing substrate and which includes a first electrode, an organic layer, and a second electrode sequentially deposited, a multilayered thin film deposited on the second electrode, and a substrate bonded to the sealing substrate. The multilayered thin film includes an inorganic protective layer, an organic protective layer, and a moisture absorbing layer. The organic electroluminescent display device significantly prevents the permeation of air and moisture at the edge of the device. Accordingly, the organic electroluminescent display device has a long lifetime.

### CLAIM OF PIROITY

This application claims the priority of Korean Patent Application No. 10-2004-0049711, filed on Jun. 29, 2004, in the Korean Intellectual Property Office, the disclosure of which is incorporated herein in its entirety by reference.

### BACKGROUND OF THE INVENTION

1. Field of the Invention

The present invention relates to an organic electroluminescent display device and a method of manufacturing the same, and more particularly, to an organic electroluminescent display device having a multilayered thin film structure including an inorganic protective layer, an organic protective layer, and a moisture absorbing layer that significantly prevents the permeation of air and moisture at the edge of the device, thus resulting in a long lifetime of the organic electroluminescent display devices, and a method of manufacturing the same.

2. Description of the Related Art

Since organic electroluminescent display devices are deteriorated by moisture and air, they need a sealed structure to prevent the permeation of moisture and air.

Conventionally, to prevent the permeation of moisture and air, a metal can or glass is processed in a cap form with a groove in which a desiccant in a powder form for absorbing moisture is disposed, or a desiccant is prepared in a film form and bonded to an organic electroluminescent display device with double-sided tape (U.S. Pat. No. 5,771,562 and Japanese Patent Publication No. Hei 03-261091). In addition, an organic compound and an inorganic compound were alternately deposited on the upper surface of an organic electroluminescent portion of a display device to form a protective layer (U.S. Pat. No. 6,570,325).

The method of using the desiccant results in high material and processing costs due to the requirement of a complicated process, and the desiccant can not be used in a top emission display or dual emission display since a substrate used for sealing the display device is not transparent due to an increase in the thickness of the substrate. Furthermore, a display device using the metal can is structurally firm, but a display device using etched glass is structurally weak and is therefore easily damaged by an external impact. Further, when sealing a display device with the film, the permeation of moisture cannot be completely prevented and when the film is chopped when preparing or using the display device, it can be easily broken. Accordingly, since the film does not have high endurance and reliability, it is difficult to practically prepare the display device with the film.

The method of alternately depositing an organic compound and inorganic compound on the upper surface of an organic electroluminescent element of a display device to form a protective layer diminishes the overall barrier property of a protective layer due to too high moisture permeability and air permeability of the organic compound containing layer. In addition, the organic electroluminescent display device employing the multiple thin film protective layer can somewhat prevent air and moisture from permeating in a central portion of the device, but not at the outer edge of the device.

### SUMMARY OF THE INVENTION

It is therefore an object of the present invention to solve the above and other problems.

It is also an object of the present invention to provide an improved organic electroluminescent display device.

It is another object of the present invention to provide an improved method of manufacturing an organic electroluminescent display device.

It is a further object of the present invention to provide an organic electroluminescent display device which can be applied to a top emission display or a dual emission display, and is structurally firm, and can significantly prevent the permeation of air and moisture at the edge of the device, thus resulting in a long lifetime, and a method of manufacturing the organic electroluminescent display device.

According to an aspect of the present invention, there is provided an organic electroluminescent display device including: a sealing substrate; an organic electroluminescent element formed on a surface of the sealing substrate, the organic electroluminescent element comprising a first electrode, an organic layer, and a second electrode sequentially deposited; a multilayered thin film deposited on the second electrode of the organic electroluminescent element, the multilayered thin film comprising an inorganic protective layer, an organic protective layer, and a moisture absorbing layer; and a substrate bonded to the sealing substrate.

It is preferred that the moisture absorbing layer includes a first moisture absorbing layer formed on the second electrode and a second moisture absorbing layer formed between the organic protective layer and the inorganic protective layer.

According to another aspect of the present invention, there is provided a method of manufacturing an organic electroluminescent display device, the method including: preparing a sealing substrate; forming an organic electroluminescent element by sequentially depositing a first electrode, an organic layer, and a second electrode on the sealing substrate; depositing a multilayered thin film including an inorganic protective layer, an organic protective layer, and a moisture absorbing layer on the second electrode of the organic electroluminescent element; and bonding a substrate to the sealing substrate.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, in which:

FIG. 1 is a photograph illustrating the deterioration at an edge of an organic electroluminescent display device according to a conventional technology; and

FIG. 2 is a cross-sectional view illustrating a schematic structure of an organic electroluminescent display device according to an embodiment of the present invention;

FIG. 3 is a cross-sectional view illustrating a schematic structure of an organic electroluminescent display device according to another embodiment of the present invention.

### DETAILED DESCRIPTION OF THE INVENTION

Hereinafter, the present invention will be described in more detail.

An organic electroluminescent display device according to an embodiment of the present invention has a multilayered thin film structure including an inorganic protective layer, an organic protective layer, and a moisture absorbing layer, and thus, air and moisture are significantly prevented from permeating at the edge of the device.

In general, a multilayered thin film protective layer including a composite layer including an organic compound and inorganic compound is effective for lengthening a path of permeation of air and moisture. However, the composite layer at an outer edge of the device is not so effective for multiple barrier layer function as the composite layer in a central portion of the device. Thus, in an embodiment of the present invention, after depositing a moisture absorbing layer on a second electrode, an organic protective layer, a moisture absorbing layer, and an inorganic protective layer are sequentially deposited so that the permeated moisture can be removed by the moisture absorbing layer on the second electrode and the moisture absorbing layer between the organic protective layer and the inorganic protective layer. Therefore, an organic electroluminescent device in which deterioration is prevented or retarded at the edge of the device is provided.

That is, although organic/inorganic composite layers are deposited on an emission region using an open mask in conventional technologies, when the layers are scribed, the permeation of moisture, etc., into a side of the device can be occurred.

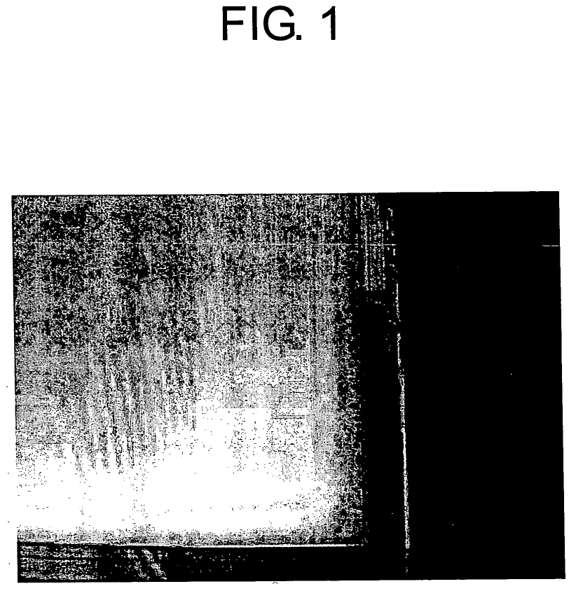

Referring to FIG. 1, it can be determined that the deterioration at the edge of a display device occurs due to the permeation of moisture through a weak portion of the side of the display device when performing an accelerated life test, etc., after manufacturing the device. This deterioration is further accelerated, since the interface between the organic/inorganic composite layer and the second electrode, a pin hole of the organic protective layer, a microcrack of the inorganic protective layer, and the like act as a path for moisture permeated from the outside. However, in an embodiment of the present invention, the path of moisture permeation can be blocked by coating the interface between the organic/inorganic composite layer and the second electrode with a moisture absorbing layer and depositing a moisture absorbing layer between the organic protective layer and the inorganic protective layer.

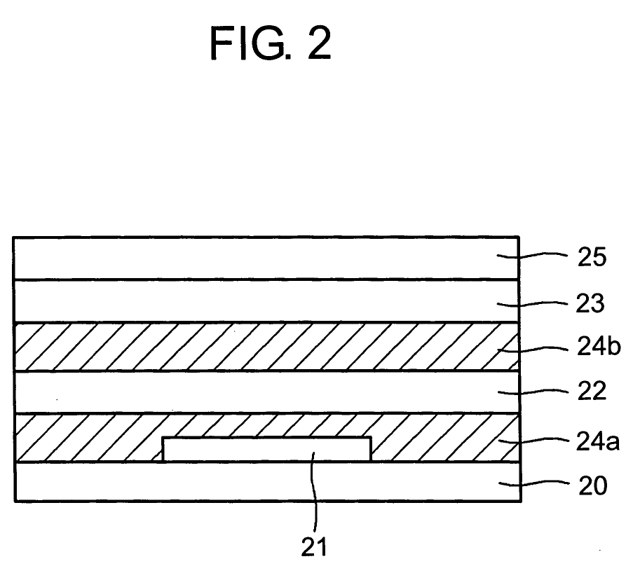

FIG. 2 is a cross-sectional view of an organic electroluminescent display device according to an embodiment of the present invention. Referring to FIG. 2, the organic electroluminescent display device includes a sealing substrate 20, an organic electroluminescent element 21 formed on a surface of the sealing substrate 20 and a multilayered thin film formed on the organic electroluminescent element 21. The organic electroluminescent element includes a first electrode, an organic layer, and a second electrode which are sequentially deposited. The multilayered thin film includes an inorganic protective layer 22, an organic protective layer 23, and a moisture absorbing layer preferably including a first moisture absorbing layer 24a and a second moisture absorbing layer 24b. The sealing substrate 20 may be bonded to a substrate 25 by a separate sealing material, etc.

In an embodiment of the present invention, a plurality of the multilayered thin films, each including an inorganic protective layer, an organic protective layer, and a moisture absorbing layer, may be stacked on the organic electroluminescent element.

The second moisture absorbing layer 24b is preferably interposed between the inorganic protective layer 22 and the organic protective layer 23 to block the path of moisture permeation.

The first moisture absorbing layer 24a is preferably deposited directly on the second electrode of the organic electroluminescent element 21.

It is preferred that the uppermost layer of the multilayered thin film is the inorganic protective layer. It is also preferred that the inorganic protective layer 22 is positioned between the first moisture absorbing layer 24a and the second moisture absorbing layer 24b.

More preferably, the first moisture absorbing layer 24a is formed on the second electrode, the inorganic protective layer 22 is formed on the first moisture absorbing layer 24a, the second moisture absorbing layer 24b is formed on the inorganic protective layer 24b, and the organic protective layer 23 is formed on the second moisture absorbing layer.

The moisture absorbing layer includes pores with an average diameter of 100 nm or less. When the average diameter of the pores is greater than 100 nm, the permeation of air and moisture cannot be effectively prevented.

The thickness of the moisture absorbing layer can be in the range of 0.1-12 μm, the thickness of the inorganic protective layer 22 can be 1 nm or less, and the thickness of the organic protective layer 23 can be 5 nm or less.

The moisture absorbing layer 24a and 24b may be formed by depositing at least one metal powder selected from the group consisting of Li, Na, K, Ba, Ca, Mg, Co, Ga, Ti, Ni, Sr, Y, Cu, Cs, Ta, Nb, Ce, Se, and V, preferably Ca, under an oxygen atmosphere. The deposition may be performed using a conventional deposition method, such as vacuum thermal evaporation, and the deposition condition should be controlled such that the moisture absorbing layer is not damaged during deposition.

The inorganic protective layer 22 may be formed of at least one material selected from the group consisting of silicon nitride, aluminium nitride, zirconium nitride, titanium nitride, hafnium nitride, tantalum nitride, silicon oxide, aluminium oxide, titanium oxide, tin oxide, cerium oxide, and silicon oxynitride (SiON), but is not limited thereto.

The organic protective layer 23 may be formed of at least one material selected from the group consisting of acryl based resins and pherylene based resins.

A method of preparing an organic electroluminescent display device according to an embodiment of the present invention includes: preparing a sealing substrate 20; forming an organic electroluminescent element 21 by sequentially depositing a first electrode, an organic layer, and a second electrode on the sealing substrate; depositing a multilayered thin film including an inorganic protective layer, an organic protective layer, and a moisture absorbing layer on the second electrode of the organic electroluminescent element; and bonding a substrate 25 to the sealing substrate.

In more detail, the sealing substrate is prepared, and an organic electroluminescent element is formed on the sealing substrate by sequentially depositing a first electrode, an organic layer, and a second electrode. Then, a multilayered thin film including an inorganic protective layer, an organic protective layer, and a moisture absorbing layer is deposited on the second electrode of the sealing substrate.

The moisture absorbing layer may be formed by depositing at least one metal powder selected from the group consisting of Li, Na, K, Ba, Ca, Mg, Co, Ga, Ti, Ni, Sr, Y, Cu, Cs, Ta, Nb, Ce, Se, and V, preferably Ca, under an oxygen atmosphere.

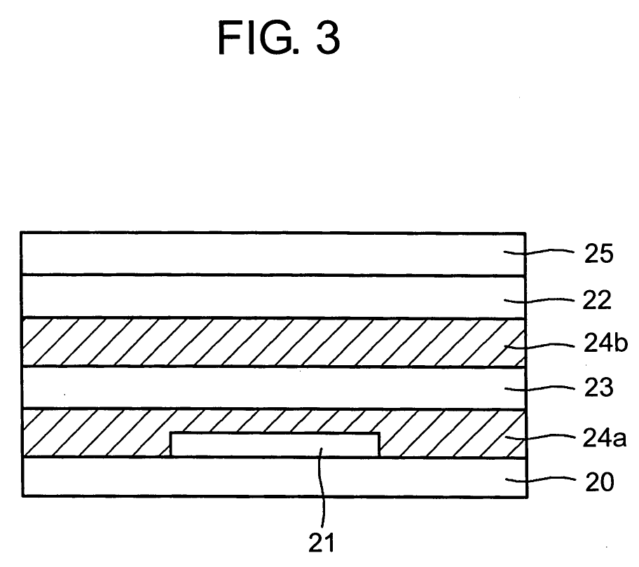

After depositing a first moisture absorbing layer on the second electrode, the inorganic protective layer is deposited on the first moisture absorbing layer using an inorganic compound (as shown in FIG. 2), or the organic protective layer is deposited on the first moisture absorbing layer using an organic compound (as shown in FIG. 3), and then a second moisture absorbing layer is deposited on the organic or inorganic protective layer. Examples of the method that may be used to deposit the inorganic protective layer include, but are not limited to, vacuum film forming methods, such as sputtering, chemical vapor deposition (CVD), e-beam thermal evaporation, and thermal ion beam assisted deposition, and examples of the CVD include induced coupled plasma-chemical vapor deposition (IPC-CVD), capacitively coupled plasma (CCP)-CVD, surface wave plasma (SWP)-CVD and the like. Examples of the method that may be used to deposit the organic protective layer include, but are not limited to, spin coating, spray coating, screen printing, bar coating, inkjet, and dispensing methods.

Then, an organic protective layer is formed on the second moisture absorbing layer when an inorganic protective layer is formed on the moisture absorbing layer in the above process (as shown in FIG. 2), or an inorganic protective layer is formed on the organic protective layer when an organic protective layer is formed on the moisture absorbing layer in the above process (as shown in FIG. 3).

The organic electroluminescent display device can be completed by bonding the sealing substrate to a substrate after depositing the multilayered thin film.

The organic electroluminescent display device according to an embodiment of the present invention can be a top emission display, a bottom emission display, or a dual emission display. Since the driving method of the organic electroluminescent display device is not particularly limited, the organic electroluminescent display device can use a passive matrix (PM) driving method or an active matrix (AM) driving method.

The present invention will now be described in greater detail with reference to the following examples. The following examples are for illustrative purposes and are not intended to limit the scope of the invention.

### EXAMPLE

A sealing substrate was prepared and an organic electroluminescent element was formed by sequentially depositing a first electrode, an organic layer, and a second electrode on the sealing substrate. Then, Ca powder with an average particle diameter of 100 nm or less was deposited by a vacuum thermal evaporated method on the second electrode under an oxygen atmosphere to form a first CaO moisture absorbing layer.

Silicon nitride was vacuum evaporated to form an inorganic protective layer on the CaO moisture absorbing layer, and then a second CaO moisture absorbing layer was coated on the inorganic protective layer in the same manner as above. An acryl based resin was spin coated on the second CaO moisture absorbing layer to form an organic protective layer, and then the organic protective layer was thermally treated at 100° C., thereby preparing a sealing substrate having the second electrode, the first moisture absorbing layer, the inorganic protective layer, the second moisture absorbing layer, and the organic protective layer.

Finally, the sealing substrate was bonded to a substrate to prepare an organic electroluminescent display device according to the present invention.

### COMPARATIVE EXAMPLE

A conventional organic electroluminescent display device was prepared in the same manner as in the previous Example, except that the CaO moisture absorbing layers were not interposed between the second electrode and the organic protective layer and between the inorganic protective layer and the organic protective layer.

Test for Permeation of Moisture and Air

Permeability of moisture and air of the organic electroluminescent display 11 devices prepared according to the Example and the Comparative Example was investigated.

The organic electroluminescent display device manufactured according to the Example had a moisture permeability of 10⁻⁶ g/m²/day or less, whereas the organic electroluminescent display device manufactured according to the Comparative Example had a moisture permeability of 10⁻⁵ g/m²/day or greater. Thus, it can be seen that the organic electroluminescent display device according to the present invention had a better ability to prevent moisture and air from permeating than the conventional organic electroluminescent display device.

An organic electroluminescent display device according to the present invention can be easily applied to a top emission display or a dual emission display, is structurally firm, and can significantly prevent the permeation of air or moisture, in particular, at the edge of the device. Thus, the organic electroluminescent display device has a longer lifetime than conventional organic electroluminescent display devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An organic electroluminescent display device, comprising:
a sealing substrate;
an organic electroluminescent element formed on the sealing substrate, the organic electroluminescent element comprising a first electrode, a second electrode and an organic layer interposed between the first electrode and the second electrode;
a multilayered thin film deposited on the second electrode, the multilayered thin film comprising an inorganic protective layer, an organic protective layer, and a moisture absorbing layer; and
a substrate bonded to the sealing substrate.

2. The organic electroluminescent display device of claim 1, wherein the moisture absorbing layer is interposed between the inorganic protective layer and the organic protective layer.

3. The organic electroluminescent display device of claim 1, further comprising a plurality of multilayered thin films disposed on the organic electroluminescent element.

4. The organic electroluminescent display device of claim 1, wherein the moisture absorbing layer is formed on the second electrode.

5. The organic electroluminescent display device of claim 1, wherein the moisture absorbing layer comprises a first moisture absorbing layer formed on the second electrode and a second moisture absorbing layer formed between the organic protective layer and the inorganic protective layer.

6. The organic electroluminescent display device of claim 1, wherein the uppermost layer of the multilayered thin film is the inorganic protective layer.

7. The organic electroluminescent display device of claim 1, wherein the moisture absorbing layer includes pores with an average diameter of 100 nm or less.

8. The organic electroluminescent display device of claim 1, wherein a thickness of the moisture absorbing layer is in a range of 0.1-12 μm.

9. The organic electroluminescent display device of claim 1, wherein a thickness of the inorganic protective layer is 1 nm or less.

10. The organic electroluminescent display device of claim 1, wherein a thickness of the organic protective layer is 5 nm or less.

11. The organic electroluminescent display device of claim 1, wherein the moisture absorbing layer is a porous oxide layer formed by depositing at least one metal powder selected from the group consisting of Li, Na, K, Ba, Ca, Mg, Co, Ga, Ti, Ni, Sr, Y, Cu, Cs, Ta, Nb, Ce, Se, and V under an oxygen atmosphere.

12. The organic electroluminescent display device of claim 11, wherein the porous oxide layer is a porous CaO layer.

13. The organic electroluminescent display device of claim 1, wherein the inorganic protective layer includes at least one material selected from the group consisting of silicon nitride, aluminium nitride, zirconium nitride, titanium nitride, hafnium nitride, tantalum nitride, silicon oxide, aluminium oxide, titanium oxide, tin oxide, cerium oxide, and silicon oxynitride (SiON).

14. The organic electroluminescent display device of claim 1, wherein the organic protective layer includes at least one material selected from the group consisting of acryl based resins and pherylene based resins.

15. A method of manufacturing an organic electroluminescent display device, the method comprising:
preparing a sealing substrate;
forming an organic electroluminescent element by sequentially depositing a first electrode, an organic layer, and a second electrode on the sealing substrate;
depositing a multilayered thin film on the second electrode, the multilayered thin film comprising an inorganic protective layer, an organic protective layer and a moisture absorbing layer; and
bonding a substrate to the sealing substrate.

16. The method of claim 15, wherein the moisture absorbing layer is a porous oxide layer formed by depositing at least one metal powder selected from the group consisting of Li, Na, K, Ba, Ca, Mg, Co, Ga, Ti, Ni, Sr, Y, Cu, Cs, Ta, Nb, Ce, Se, and V under an oxygen atmosphere.

17. The method of claim 15, wherein the depositing of the multilayered thin film comprises placing the moisture absorbing layer between the inorganic protective layer and the organic protective layer.

18. The method of claim 15, wherein the depositing of the multilayered thin film comprises forming the moisture absorbing layer on the second electrode.

19. The method of claim 15, wherein the moisture absorbing layer comprises a first absorbing layer and a second absorbing layer, and the depositing of the multilayered thin film comprises forming the first moisture absorbing layer on the second electrode, forming the inorganic protective layer on the first moisture absorbing layer, and the second moisture absorbing layer on the inorganic protective layer, and forming the organic protective layer on the second moisture absorbing layer.

20. An organic electroluminescent display device manufactured by the method of claim 15.

21. An organic electroluminescent display device, comprising:
a sealing substrate;
an organic electroluminescent element formed on the sealing substrate, the organic electroluminescent element comprising a first electrode, an organic layer, and a second electrode sequentially deposited;
a multilayered thin film deposited on the second electrode, the multilayered thin film comprising an inorganic protective layer, an organic protective layer, and a moisture absorbing layer; and
a substrate bonded to the sealing substrate.
